(19) United States
(12) Patent Application Publication
(10) Pub. No.: US 2008/0085019 A1
(43) Pub. Date: Apr. 10, 2008

(54) Display Device Comprising a Panel Acoustic Transducer, and Transparent Panel Acoustic Transducer

(75) Inventors: Wilhelmus Maria Wagenaars, Leuven (BE); Christiaan Michel Willy Gouwy, Brugge (BE); Dieter Marie Roger Debels, Brugge (BE); Johannes Hermanus Van Den Tillaar, Eindhoven (NL); Peter Gilbert Clement De Pauw, Dendermonde (BE); Harry Van Brussel, Dendermonde (BE); Geert Joseph Maria Loeys, Brugge (BE); Mart P.M. Van Den Thillart, Brugge (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,550

(22) PCT Filed: Oct. 3, 2005
(86) PCT No.: PCT/IB05/53244

§ 371 Date: Apr. 3, 2007

(30) Foreign Application Priority Data
Oct. 8, 2004 (EP) 04104921.4

(51) Int. Cl. H04R 7/02; H04R 5/02; H04R 7/00

(52) U.S. Cl. 381/152

(57) ABSTRACT

A display device (1) comprises a transparent panel acoustic transducer (6). The transparent front panel (6) has a laminate comprising an outer transparent thin panel (6b) and a supporting panel (6a). The supporting panel (6a) has a considerably larger stiffness than the transparent thin panel (6b), and the transparent thin panel (6b) comprises, at at least one side of the supporting panel, a side area (7) extending beyond the supporting panel (6a), said extending side area (7) being provided with an exciter (8) or a receiver at a side facing the display screen (2).

### FIELD OF THE INVENTION

The invention relates to a display device comprising a panel acoustic transducer.

Panel acoustic transducers are, for instance, panel speakers and panel microphones.

Panel speakers are used for sound-generating devices, such as loudspeakers, and are often used as a part of another device such as a mobile telephone, radio, television, etc. Panel microphones are used to record sound.

The invention also relates to a transparent panel acoustic transducer.

### BACKGROUND OF THE INVENTION

The use of panel acoustic transducers offers the possibility of reducing the size and/or weight of a device in comparison with devices comprising standard loudspeakers, so that new designs become possible.

It is known to place transducers behind the front panel. In devices in which the loudspeakers are behind the front panel, holes have to be provided in the panel so as to allow free air movement. These holes are undesirable.

It is known, for instance, from International Patent application WO 97/09854, to place panel acoustic transducers next to the display device in the form of rectangular flat panel loudspeakers that are flush-mounted with the front of the display. However, for these flat panel loudspeakers, it is necessary that the two long sides of the panel acoustic transducers can vibrate freely. This means that these loudspeakers have to be separate parts, rather than parts of the front panel itself, which increases the complexity of the device and of its manufacture. Moreover, they are distinguishable as separate parts, which has a distracting effect on the overall impression of the design.

Placing the panel acoustic transducer in front of the display screen, using a transparent acoustic transducer, is known from United States Patent 2003059069, wherein a transparent acoustic transducer formed as a transparent front panel is described. It is positioned in front of a display screen, such as, for instance, a display screen of a mobile phone or an LCD or PDP display. However, this design has a negative influence on the quality of the image. The transparent acoustic transducer vibrates. Consequently, reflections of lamps and other objects in this front panel also vibrate and thus distract the viewer, because visible artefacts are created. In particular, vibrations of the front panel are visible at low frequencies (<400 Hz) due to the large excursion in the middle of the front panel. Furthermore, the exciters required to generate the sound have to be on the side of the front panel so as to allow the display screen to remain visible, which makes the excitation not very efficient, especially at low frequencies. For this reason, a number of powerful exciters have to be used at each side of the panel. Moreover, much of the power of the rather powerful exciters is not transferred to the panel itself, but to other parts of the display device.

### OBJECT AND SUMMARY OF THE INVENTION

It is an object of the invention to provide a display device having a panel acoustic transducer with a relatively simple design which at least reduces one or more of the above-mentioned problems.

To this end, the display device is characterized in that it comprises a transparent front panel, positioned in front of a display screen, the transparent front panel having a laminate comprising an outer transparent thin panel and a supporting panel, wherein the supporting panel has a considerably larger stiffness than the transparent thin panel, and wherein the transparent thin panel comprises, at at least one side of the supporting panel, a side area extending beyond the supporting panel, said extending side area being provided with an exciter or receiver at a side facing the display screen.

The invention is based on the following recognition.

The thin panel and the supporting panel are combined to a laminate, i.e. to one construction, with one or more side areas that can vibrate freely, and a middle area that does not vibrate, or vibrates at least to a much smaller extent, due to the stiffness of the supporting panel.

With this arrangement, there is no visible distinction between the transducer or transducers and the front panel, nor are there visible artefacts, because

the outer thin panel extends across the supporting panel, forming a single front surface, and

the middle part of the front panel does not vibrate or hardly vibrates, thus avoiding visible artefacts.

Furthermore, the freely vibrating areas are excited very efficiently, because the side area of the thin panel is provided with an exciter.

The display device according to the invention may be a panel speaker, a panel microphone or even a combination of both, dependent on the presence of one or more exciters and/or one or more receivers.

In a preferred embodiment, the thin panel has at least two side areas at opposing sides of the panel, each side area being provided with an exciter or receiver. This increases the efficiency and also makes it possible to produce stereo sound.

In a preferred embodiment, the supporting panel is provided with one or more stiffening parts on a peripheral part of the supporting panel.

Such stiffening parts increase the stiffness of the supporting panel, allowing a reduction of weight. In preferred embodiments, the stiffening parts may be used as a mount for other elements, such as a display screen.

The invention also relates to a transparent panel acoustic transducer having a laminate comprising an outer transparent thin panel and a supporting panel, wherein the supporting panel has a considerably larger stiffness than the transparent thin panel, and wherein the transparent thin panel comprises, at at least one side of the supporting panel, a side area extending beyond the supporting panel, said extending side area being provided with an exciter or receiver next to the supporting panel.

Embodiments of the panel acoustic transducer according to the invention are defined in claims 5 and 6.

These and further aspects of the invention will be explained in greater detail by way of example and with reference to the accompanying drawings.

### BRIEF DESCRIPTION OF THE DRAWINGS

FIG. 1 schematically shows a display device,

FIGS. 2A and 2B schematically show known configurations for a display device with loudspeakers (FIG. 2A) and side acoustics panels (FIG. 2B),

FIG. 3 schematically shows a detail of a display device according to the invention,

FIG. 4 shows a transparent panel acoustic transducer according to the invention,

FIG. 5 schematically shows a detail of a further example of a display device according to the invention.

The Figures are not drawn to scale. Generally, identical components are denoted by the same reference numerals in the Figures.

### DESCRIPTION OF EMBODIMENTS

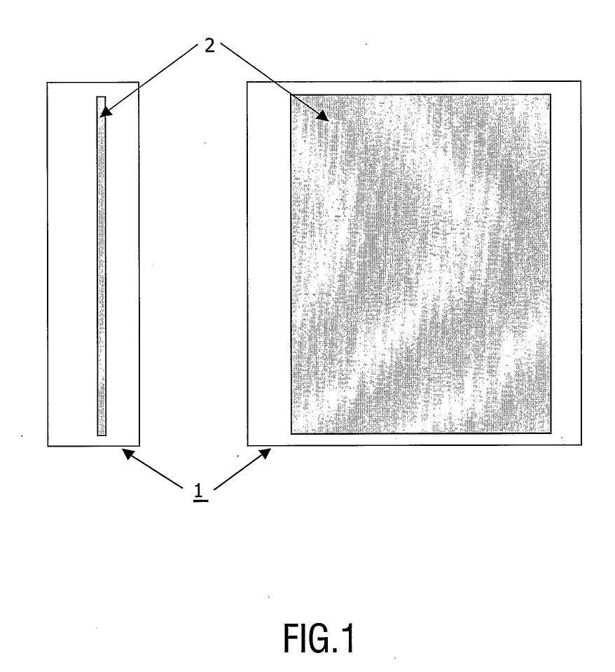

FIG. 1 shows schematically a display device 1 comprising a display screen 2 in an envelope 3. Within the scope of the present invention, ‘display screen’ may be any display, for instance, an LCD or a PDP or any other flat type display, or a CRT display, i.e. any apparatus for displaying an image.

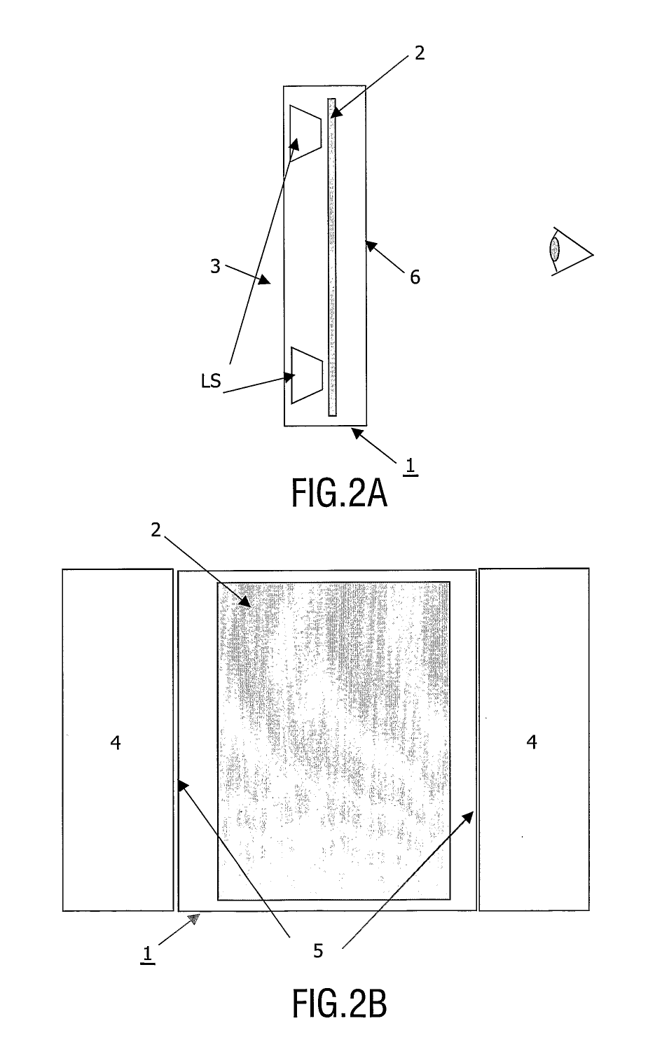

Such display devices are often provided with means for generating sound. Conventional loudspeakers are generally used to generate sound. Flat panel acoustic transducers are used in the device according to the invention. Such transducers offer advantages over conventional loudspeakers in that they are flat. FIG. 2A shows a configuration in which loudspeakers LS are provided behind the screen 2. However, holes then have to be provided so as to allow free air movement. These holes are undesirable.

It is known, for instance, from International Patent application WO 97/09854 to place panel acoustic transducers 4 next to the display panel in the form of rectangular flat panel loudspeakers that are flush-mounted with the front of the display device. However, for these flat panel loudspeakers, it is necessary that the two long sides of the panel can vibrate freely. This means that these loudspeakers have to be separate parts, rather than part of the front panel itself, which increases the complexity of the device and of its manufacture. Moreover, these separate flat panel loudspeakers are distinguishable as separate parts, which has a distracting effect on the overall impression of the design because slits 5 are clearly visible.

Placing a panel acoustic transducer 6 in front of the display screen 2, using a transparent panel acoustic transducer 6, is known from United States Patent 2003059069, wherein a transparent panel acoustic transducer formed as a transparent front panel is positioned in front of a display screen. The display screen itself may be, for instance, a display screen of a mobile phone, or an LCD or PDP display.

This design, however, has a negative influence on the quality of the image. The transparent acoustic transducer vibrates. Consequently, reflections of lamps and other objects in this front panel also vibrate and thus distract the viewer, because visible artefacts are created. In particular, vibrations of the front panel are visible at low frequencies (<400 Hz) due to the large excursion in the middle of the front panel. Furthermore, the exciters required to generate the sound have to be on the side of the front panel so as to allow the display screen to remain visible, which makes the excitation not very efficient. For this reason, a number of powerful exciters have to be used at each side of the panel. Moreover, much of the power of the rather powerful exciters is not transferred to the panel itself, but to other parts of the display device.

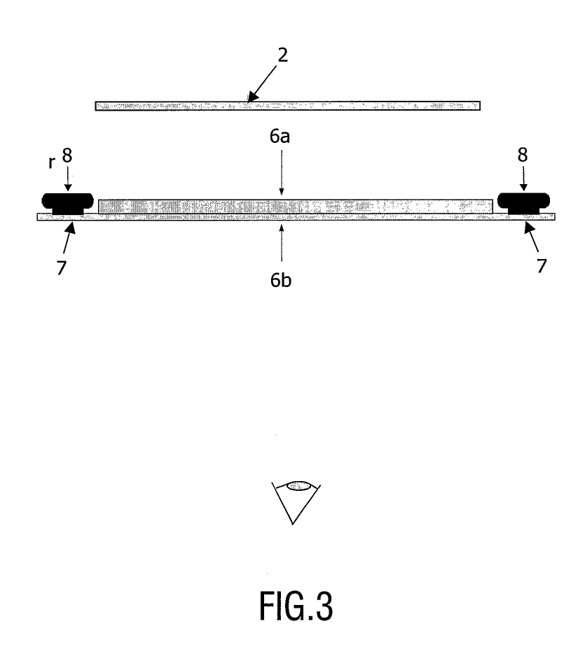

FIG. 3 illustrates a detail of a display device according to the invention. The display device comprises a transparent front panel 6 with a laminate comprising

an outer transparent thin panel 6b and

a supporting panel 6a,

wherein

the supporting panel 6a has a considerably larger stiffness than the transparent thin panel 6b, and

the transparent thin panel 6b comprises, at at least one side of the supporting panel, a side area 7 extending beyond the supporting panel 6a, said extending side area 7 being provided with an exciter 8 at a side facing the display screen 2.

The thin panel and the supporting panel are combined to a laminate, i.e. to one construction, with one or more side areas that can vibrate freely, and a middle area that does not vibrate, or vibrates at least to a much smaller extent, due to the stiffness of the supporting panel.

It is to be noted that, within the scope of the invention, the laminate may comprise additional layers, for instance, anti-glare or anti-scratch layers for optical or safety reasons.

With this arrangement, in which the thin panel extends across the supporting panel, there is no visible distinction between the transducer or transducers and the front panel, nor are there visible artefacts, because

the outer thin panel extends across the supporting panel, forming a single front surface, and

the middle part of the front panel does not vibrate or hardly vibrates, thus avoiding visible artefacts.

The transparent thin panel 6b is glued, for instance, on top of the transparent stiff supporting panel 6a. The exciters (8), for making the front panel vibrate, are mounted at the back of the thin panel 6b at the side areas 7.

Different panel materials can be used, as long as they fulfil acoustical and visual requirements.

Useful materials for the transparent thin panel are thin glass and polycarbonate. A useful material for the supporting panel is glass.

The freely vibrating side areas 7 are excited very efficiently, because the side area is provided with an exciter.

The thin panel may have one, but preferably two side areas, each side area being provided with one or more exciters. This increases the maximum attainable loudness and also makes it possible to produce stereo sound.

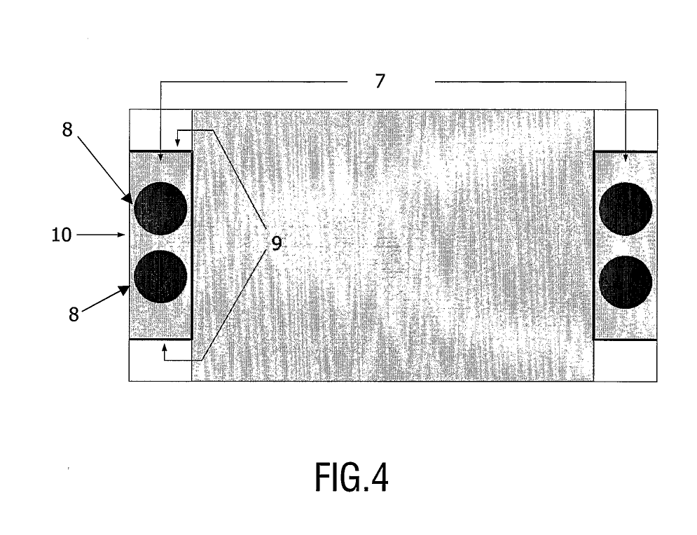

The supporting panel 6a has such dimensions that it covers the display area, while the thin panel 6b can vibrate freely at the sides. The vibrating area may have a smaller height than the total panel so that the thin panel is fixed at the top and bottom as well, thus leaving only one freely vibrating side. FIG. 4 shows an embodiment of a transparent front plate by way of example, in which the side areas have a smaller height than the total panel and in which the sides 9 are fixed and the side 10 is free.

The supporting panel 6a has a stiffness which is preferably at least three times, more preferably at least five times, and most preferably at least ten times larger than the stiffness of the thin panel 6b.

The following materials may be used for thin panel 6b and supporting panel 6a.

Thin panel 6b: hardened glass with a thickness of between 0.2 and 1 mm, for instance, 0.5 mm, or polycarbonate with a thickness of between 0.4 and 2 mm, for instance, 1 mm, covering a supporting panel 6a of glass or polycarbonate with a thickness of between 2 and 10, preferably between 3 and 7 mm.

In summary, the invention can be described as follows.

A display device 1 comprises a transparent panel acoustic transducer 6. The transparent front panel 6 has a laminate comprising
an outer transparent thin panel 6b and
a supporting panel 6a.

The supporting panel 6a has a considerably larger stiffness than the transparent thin panel 6b, and the transparent thin panel 6b comprises, at at least one side of the supporting panel, a side area 7 extending beyond the supporting panel 6a, said extending side area 7 being provided with an exciter 8 or a receiver at a side facing the display screen 2.

It will be clear that many variations are possible within the scope of the invention. It will be appreciated by persons skilled in the art that the present invention is not limited by what has been particularly shown and described hereinbefore.

For instance, the laminate of the thin panel and the supporting panel may be provided with a stiffening part which is attached to the supporting panel at one or more peripheral parts of this panel.

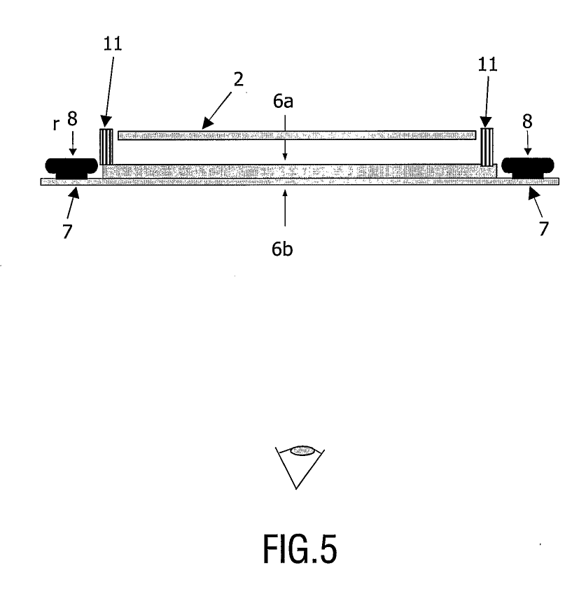

FIG. 5 shows such an arrangement. The provision of a stiffening part 11 on a peripheral part of the supporting panel 6a has the advantage of increasing the stiffness of the central area. The stiffening part 11 may be, for instance, a support ring all around the circumference of supporting panel 6a, or stiffening ridges at two sides of the supporting panel. The stiffening part or parts 11 may be used to mount other elements of the device, such as the display screen.

Furthermore, the example given above relates to a display device for display screens such as PDP, LCD, etc. Within the scope of the invention, the ‘display screen’ may also be a picture or a painting, in which case the ‘display device’ is, for instance, a frame for a picture with a front plate. For instance, in a museum, paintings may be provided with transparent acoustic transducers of the invention which provide information on the image visible through the transparent acoustical transducers, without distracting from the painting.

The transparent acoustic transducer may be flat or (slightly) curved.

In the example, the transparent acoustic transducer is shown with exciters, i.e. the transducer is used to generate sound. Within the scope of the invention, the side areas or one or more of the side areas may be provided with a receiver. For instance, one or two of the extending side areas may be provided with an exciter to generate sound, and another extending side area may be provided with a receiver. This allows two-way communication, without any visible loudspeakers or microphone.

The invention resides in each and every novel characteristic feature and each and every combination of characteristic features. Reference numerals in the claims do not limit their protective scope. Use of the verb “comprise” and its conjugations does not exclude the presence of elements other than those stated in the claims. Use of the article “a” or “an” preceding an element does not exclude the presence of a plurality of such elements.

1. A display device (1) comprising a panel acoustic transducer, wherein the display device comprises a transparent front panel (6), positioned in front of a display screen (2), the transparent front panel (6) having a laminate comprising
an outer transparent thin panel (6b) and
a supporting panel (6a),
wherein the supporting panel (6a) has a considerably larger stiffness than the transparent thin panel (6b), and
the transparent thin panel (6b) comprises, at at least one side of the supporting panel, a side area (7) extending beyond the supporting panel (6a), said extending side area (7) being provided with an exciter (8) or a receiver at a side facing the display screen (2).

2. A display device as claimed in claim 1, wherein the thin panel (6b) has at least two side areas (7) at opposing sides of the panel, each side area being (7) provided with an exciter (8) or a receiver.

3. A display device as claimed in claim 1, wherein the supporting panel (6a) is provided with one or more stiffening parts (11) on a peripheral part of the supporting panel (6a).

4. A transparent panel acoustic transducer having a laminate comprising
an outer transparent thin panel (6b) and
a supporting panel (6a),
wherein the supporting panel (6a) has a considerably larger stiffness than the transparent thin panel (6b), and
the transparent thin panel (6b) comprises, at at least one side of the supporting panel, a side area (7) extending beyond the supporting panel (6a), said extending side area (7) being provided with an exciter (8) or a receiver next to the supporting panel (6a).

5. A transparent panel acoustic transducer as claimed in claim 4, wherein the thin panel (6b) has at least two side areas (7) at opposing sides of the panel, each side area (7) being provided with an exciter (8) or a receiver.

6. A transparent panel acoustic transducer as claimed in claim 4, wherein the supporting panel (6a) is provided with one or more stiffening parts (11) on a peripheral part of the supporting panel.
